(19) United States
(12) Patent Application Publication
(10) Pub. No.: US 2024/0159067 A1
(43) Pub. Date: May 16, 2024

(54) A Safety System

(71) Applicant: Greenwich Innovation, Burraneer (AU)

(72) Inventors: Glen Laai Mekuri, West Hoxton (AU); Chris Bulmer, Burraneer (AU); Mafiata Paratua, Padstow (AU)

(21) Appl. No.: 17/769,670

(22) PCT Filed: Oct. 16, 2020
(86) PCT No.: PCT/AU2020/051114

§ 371 Date: Apr. 15, 2022

(30) Foreign Application Priority Data
Oct. 17, 2019 (AU) 2019903918

(51) Int. Cl. E04G 5/00; E04G 5/02; G08B 21/02

(52) U.S. Cl. CPC E04G 5/002; E04G 5/025; G08B 21/02

(57) ABSTRACT

A safety system (1) for scaffolding on a construction site having a plurality of elongate scaffolding elements (5) connected together by a plurality of couplers (7) to form a scaffolding structure (2). One or more elements connected to one or more base plates supporting the structure on a surface. At least two safety monitors (10) spaced apart about said structure. Each said monitor having a power source, a sensor and a transmitter. The sensor sensing movement in said structure and transmitting a signal to a receiver to indicate movement in the structure.

### FIELD OF THE INVENTION

The present invention relates to a safety system for construction sites and in particular a safety system for scaffolding or the like which includes a monitoring system of scaffolding element movement.

Though a preferred example of scaffold system monitoring is described below, it will be appreciated that the present invention can be utilised in many different areas, such as, but not limited to, penetration holes, access covers, doors and windows, nurse calls, formwork, lifts and cranes, containers, vehicles and other vulnerable elements.

### BACKGROUND

Construction of structures is common throughout the world. Over time, these structures have grown in height, making it more dangerous for workers. To assist those workers and keep them safe, scaffolding was invented. Scaffolding is typically a combination of elongate poles and boards coupled together to form a temporary structure to support workers and materials at height.

Scaffolding safety has come under intense scrutiny in recent times. Industry codes of practice and standards are well understood but continuously monitoring the scaffolding (and other vulnerable elements) in the dynamic and often chaotic environment of a construction site often fails. Conventional methods are not effective in providing adequate continuous monitoring. Typically, scaffold is checked manually by a person following a checklist. Hopefully that person is sufficiently trained and diligent.

In today's dynamic construction environments, there is an ever-increasing need to ensure that there are systems in place which proactively monitor the ongoing safety of the workers and their processes and equipment. This is particularly true for temporary structures required for the safe delivery of the construction of a building. Accordingly, there is a need to take away the likelihood of human error by creating a 24 hr safety monitoring system that ensures the continued compliance of safe scaffolding (and other vulnerable elements) on site.

There is also a need for a simple monitoring device which is attached to safety critical elements such as couplings and baseplates to advise an operator of unwanted movement of those elements. The device being activated by a hand-held device such as a tablet, smart phone or the like for example.

### OBJECT OF THE INVENTION

It is an object of the present invention to substantially overcome or at least ameliorate one or more of the above disadvantages.

### SUMMARY OF INVENTION

There is disclosed herein a safety system for scaffolding on a construction site, the scaffolding having a plurality of elongate scaffolding elements connected together by a plurality of couplers to form a scaffolding structure; one or more elements connected to one or more base plates supporting the structure on a surface;

at least two safety monitors, said monitors spaced apart about said structure, each said monitor having a battery, a sensor and a transmitter; said sensor sensing movement in said structure and transmitting a signal to a receiver to indicate movement in the structure.

Preferably, the monitor is connected adjacent a said coupler.

Preferably, the monitor is connected adjacent a said base plate.

Preferably, said receiver is located at a monitoring station at said construction site, the monitoring station translating the signal and transmitting resultant translated information to a receiving software application.

Preferably, said receiving software application is accessible via a desktop and/or a mobile device.

Preferably, said monitor is fastened by a fastener about said element and/or said coupler.

Preferably, said fastener includes an electrical wire that is lashed to said structure limiting access to the element and/or coupler and registering a change in state by way of the sensor should the wire be tampered with.

Preferably, each said monitor transmits a signal to said monitoring station to provide the receiving software with information regarding a status of the monitors.

Preferably, at least one said monitor includes a visual and/or audible alert should movement of said structure be sensed by said receiver.

### BRIEF DESCRIPTION OF DRAWINGS

FIG. 1 is an example of a typical scaffolding system (source:
https://www.osha.gov/laws-regs/regulations/standardnumber/1926/1926SubpartLAppE);

FIG. 2 is a safety system of an embodiment of the present invention;

FIG. 3 is a baseplate safety system of an embodiment of the present invention;

FIG. 4 is a nut monitor of an embodiment of the present invention;

FIG. 5 is a tie monitor of an embodiment of the present invention;

FIG. 6 is a pad monitor of an embodiment of the present invention; and

FIG. 7 is an embodiment of the present invention installed on a scaffolding component.

### DETAILED DESCRIPTION OF THE PREFERRED EMBODIMENTS

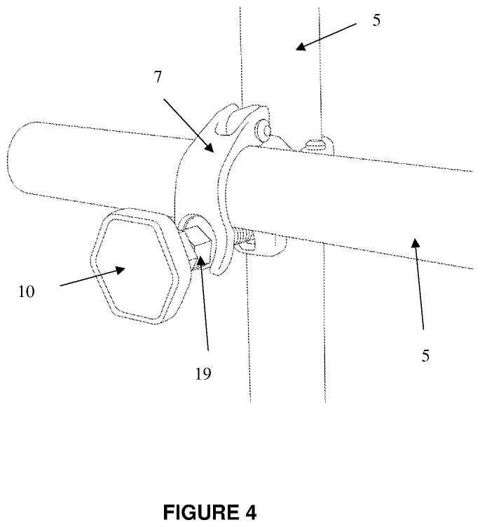

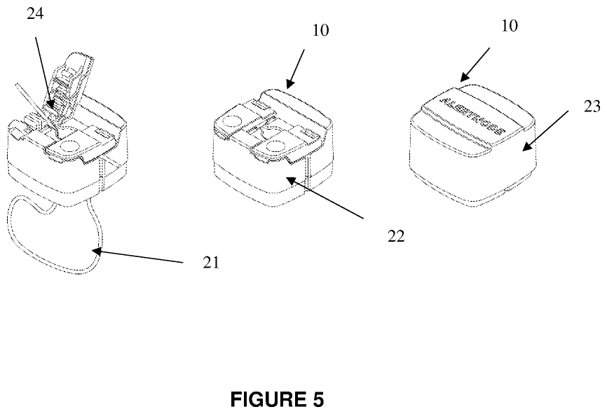

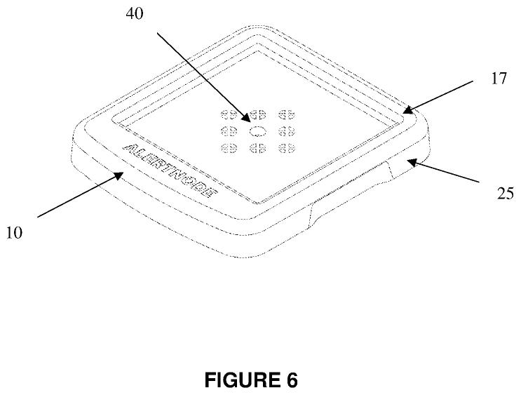

There is disclosed herein a safety system 1 for scaffolding 2. The scaffolding 2 having a plurality of elongate scaffolding elements 5 connected together by a plurality of couplers 7 to form a scaffolding structure 2. The system 1 includes at least two safety monitors 10 spaced apart about the structure. Each monitor 10 having at least a power source (such as a battery, solar, mains or the like), sensor and transmitter. The sensor sensing movement in the structure and transmitting a signal to a receiver to indicate movement in the structure. The monitors could include a Smart Nut (FIG. 4), Smart Tie (FIG. 5) and/or Smart Pad (FIG. 6).

The locations of the monitors or nodes 10 should also be related to the detailed design drawing of the structure to be constructed. When a number of monitors 10 are activated, addressed and location-tagged this will form part of a self-monitoring network where all nodes can transmit status changes (fault detected) to a central management monitoring station (gateway) where information is logged and alerts pushed forward to site personnel on the receiving software applications (such as a phone, tablet or the like). When changes to a structure 2 are required and nodes 10 must be moved or relocated, the management software, in the form of a web and mobile application, is used to plan and execute this activity and also to revalidate the network while still providing continuous monitoring of all other nodes on site eliminating human error. The dismantling sequence of the scaffolding 2 may also be programmed into the system as both an alert condition and as a prompt, further reducing the risk of human error. If nodes 10 do not transmit regular updates, the monitoring station (gateway node) and/or receiver, the system will also generate alerts which will require inspection, testing and possible replacement of the faulty unit.

Though in one embodiment the system can be a ‘mesh’ of nodes that talk to one another in a preferred form the nodes each talk to the monitoring station individually via a LoRA network. The LoRA network is a lot stronger (move penetrative) and more reliable then RF (radio frequency). That is, the safety monitoring system is a network of active alerts which are installed on site to provide 24 hr ‘anti-tamper’ monitoring. Primarily, the monitors are used for critical structural points on scaffolding and temporary structures, however, can also be used to protect other hazard zones or safety features, such as, but not limited to, penetration holes, access covers, doors and windows, nurse calls, formwork, lifts and cranes, containers, vehicles and other vulnerable elements.

The system works through the wireless connection of a web of monitors or nodes. This web of nodes continuously communicates to the monitoring station providing feedback on the nodes statues. If a node is tampered with, removed or disturbed abnormally, prior to the planned removal date, an alert message is sent to the registered project team members and/or other parties. The relevant Project Team member, which in most cases is the Site Supervisor can then take remedial actions, ensuring continued site safety.

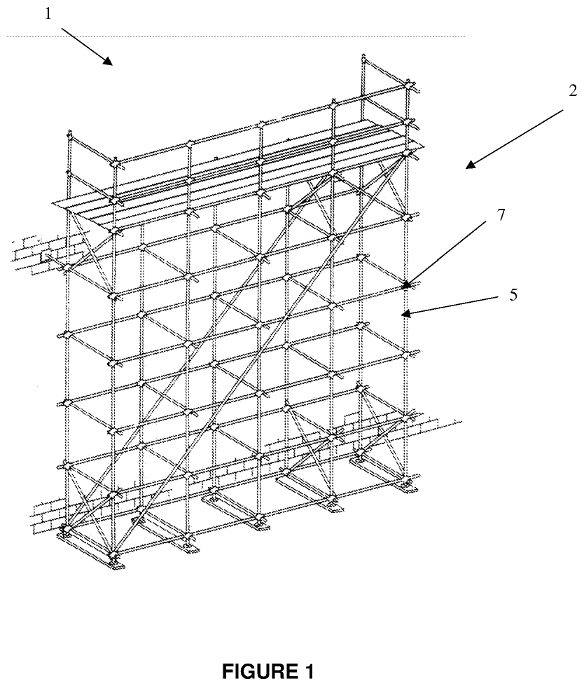

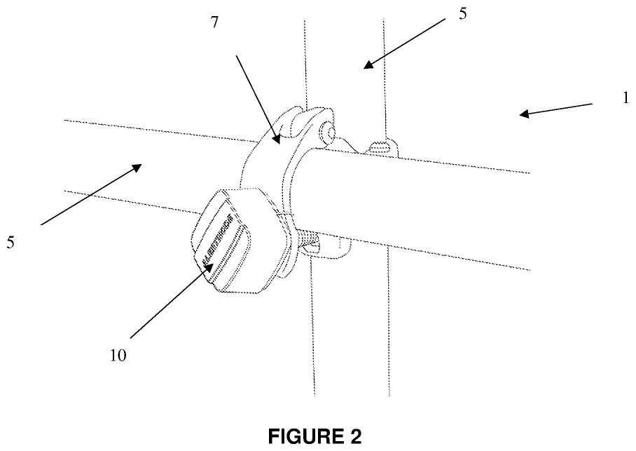

As best seen in FIGS. 2 and 5, the devices (nodes, tags or monitors 10) each consist of a low power, high range transceiver module (or equivalent technology), a long-life battery, microcontroller and sensors that monitors changes in state. The nodes also have the option of indicator LEDs to show status. The nodes can achieve a long service life due to the low power requirements of transmitting to the sites monitoring station. Alternatively, the monitor 10 can use a meshed network where each device only needs to be able to communicate with its nearest neighbour as opposed to interfacing with a remote monitoring station However, longer life batteries, solar panels, and/or mains power could also be used. FIG. 4 shows a similar node 10 but in the form of a smart nut or a node 10 attached to an existing nut 19. FIG. 5 shows a similar node 10 but with the fastener including an electrical wire 21 that is lashed to the structure 2 limiting access to the element and/or coupler 7 and registering a change in state by way of the sensor should the wire 21 be tampered with. The node 10 in this form can have a base housing 22 and a cap 23. The wire 21 being connected electrically to the base housing 22 by way of one or more arms 24 which can snap lock or the like to the base housing 22.

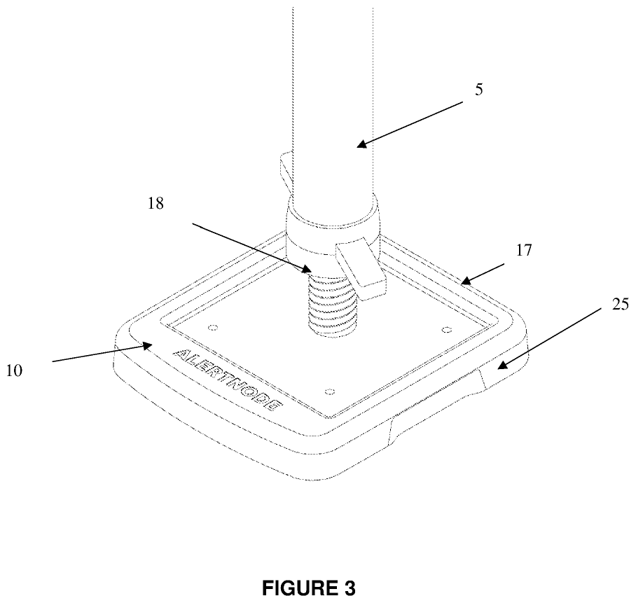

As best seen in FIGS. 3 and 6, nodes 10 could be attached to a baseplate 25 and use the same transceiver module as all other nodes in the system 1 but with a more sensitive antenna and larger battery and/or power supply. The main sensor (40) is a load/pressure sensor embedded in the plate 25 which detects when vertical loads (acting downwards) are applied or removed as well as some analogue information pertaining to load. The node 10 is embedded in a high-vis, UV-stable, IP65-rated plastic housing 17 which is suitable to harsh environments. The same logic that applied to the coupling-affixed nodes 10 also applies to the baseplates 25 with the exception of tamper as removal of the baseplate 25 following subsequent de-tensioning of the jacking assembly 18 will lead to an immediate alert. In an embodiment, the baseplate 25 is also useable as the base station as it contains a USB port which connects to the main PC. Using a baseplate 25 as the base station improves signal strength and allows the base station to be placed further away from the main nodal array.

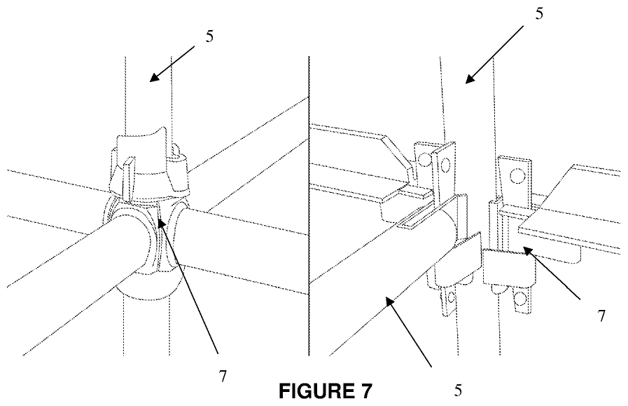

In addition to the alert node system able to be added to an erected scaffold 2 and therefore provide ongoing monitoring, the alert node system can be incorporated and accommodated within actual components of proprietary scaffold systems, see FIG. 7.

While the system 1 was primarily designed to serve the building industry for the purposes of monitoring and managing compliance with scaffolding 2, the system can be easily applied to other areas as set out below, for example.

The system 1 can monitor containers in a yard for both security (locked/lock tamper) and also location and movement (using on-board accelerometers). The same tags (nodes 10) may also be placed on equipment handling and transporting assets fitted with nodes (motes) so that interactions can be supervised and logged.

This may also be used in tamper evidence across materials handling systems such as belt conveyors or underground boring machinery or the like. When used underground, an alternate embodiment of the network architecture creates its own self-healing communication system which can also serve as a back-up emergency call network.

The network capability tied-in with the range of sensor inputs which can be added to the nodes 10 i.e. Temp, RH, Conductivity, LUX means that farming applications are possible. The nodes 10, when distributed in large numbers, form a powerful network which can span hundreds of acres that is only limited by signal access the monitoring stations. Extra monitoring stations are easily set up and mesh together to allow movement of the devices across the whole site. This kind of network, when combined with AI/Deep Learning Algorithms, can be used to detect small environmental changes and to help devise strategies to make better use of resources i.e. water, soil, biomass, solar access or the like.

The invention, in an embodiment, provides an integrated product service where the node system 1 works via a leased product model which is serviced by the applicant for the duration of the project. It is waterproof & durable as the product casing is made from a robust, tamper-proof molding and sealed to an ingress protection rating of IP57 (dust and waterproof). It includes instant alert messages. The system is managed by a central monitoring station unit which contains a small embedded PC with a LoRA transceiver gateway (or equivalent) which generates warning and critical alerts to the web/mobile application, email and SMS. There is also intelligent condition monitoring. With an array of on-board sensors, the nodes 10 constantly monitor for changes in environmental conditions i.e. physical node tampering/interference and other high frequency vibrations or abnormal disturbances. All nodes communicate with the monitoring station using a low power, high range frequency signal that is secured using high level encryption. There are multiple forms of the nodes 10 all integrated into one system 1. Thread-mounted, multi-function tie-on and load-sensing footpad; all serviced by the same monitoring station and alert system. The software logs and stores information of an individual nodes deployment history, state changes and critical data, much like a flight data recorder (FDR). This data can be recalled via the application for site safety assessments. There is a simple interface. The software has a simple user interface (UI) with an intuitive menu design which allows for management of tags when modifying, removing or expanding the scaffold design. It is un-hackable when first installed, the nodes 10 are set up using a localised scanning and registering process. Without access to the physical node 10 or a register login on the app, the encrypted nodes are protected from external wireless interference or compromise. There is Modifiable software. The software can be modified to suit the client's own Quality Management Requirements. For extremely large sites, multiple monitoring stations can be networked to provide even more coverage.

The security industry already uses remote input/output modules in typical site-based systems but a system based on the low power, high range node system 1 can be easily movable, quickly setup and redeployed with no waste. As described in the farming application above, sensors can be easily integrated to the nodes 10 i.e. Passive Infra-Red (PIR) & Microwave Detectors, limit/trip sensors and even simple pre-programmed CCD cameras.

Companies that deploy temporary site fencing typically experience loss of assets though theft and unwanted removal and variations to schemes. RFID and NFC tags can be used but these can only be scanned at a very close range. Tags (nodes) 10 that detect clusters of assets are ideal for asset tracking and tamper evidence. A tag placed on a gate in a yard with a temporary fence can be used to monitor site access and vehicle movements as well as the regular checks by security patrols (they also carry a tag).

High value ingredients and pallets of goods stored in large facilities can also be tracked and monitored in real time or by records (integrated with GMP procedures). High value pallets or bulk containers can have an asset tag 10 placed on the tap or outflow point and the tag will react when removed. Goods in cold storage can also be temperature-tracked as nodes will be designed to have an operating temperature range of −20 to +70 DegC.

Concrete formwork may be tracked for placement and correct removal during construction with additional parts, ties and support items being asset-tracked through QR or RFID methods using the system-specific Tablet or other mobile device. The tracking information of slab-critical elements combined with scanned items would be able to form part of a risk management and procedural control system.

The nodes 10 can be fitted with large push buttons and given the small size and minimal weight, can be worn on a lanyard or wristband for use as a patient call system. The integrated accelerometer would also be useful to track slips and falls and these events would trigger alarms, SMS's and other alerts. Patient tracking would also be possible as the nodes would be tracked when they leave or move through a mesh network. Some simple patient monitoring sensors may be integrated which would classify these as a wearable medical device, but simple movement tracking would be sufficient to support the needs of nurses and nursing home careers.

Nodes 10 may also be fitted into speed bumps or embedded in floor plates or covers to monitor traffic and access. Notifications based on certain detection conditions can be useful for site managers who want to understand the difference between a small vehicle or concrete truck entering site.

Although the invention has been described with reference to specific examples, it will be appreciated by those skilled in the art that the invention may be embodiment in many other forms.

1. A safety system for scaffolding on a construction site, the scaffolding having a plurality of elongate scaffolding elements connected together by a plurality of couplers to form a scaffolding structure; one or more elements connected to one or more base plates supporting the structure on a surface;
at least two safety monitors, said monitors spaced apart about said structure, each said monitor having a power source, a sensor and a transmitter;
said sensor sensing movement in said structure and transmitting a signal to a receiver to indicate movement in the structure.

2. The safety system of claim 1, wherein the monitor is connected adjacent a said coupler.

3. The safety system of claim 1, wherein the monitor is connected adjacent a said base plate.

4. The safety system of claim 1, wherein said receiver is located at a monitoring station at said construction site, the monitoring station translating the signal and transmitting resultant translated information to a receiving software application.

5. The safety system of claim 4, wherein said receiving software application is accessible via a desktop and/or a mobile device.

6. The safety system of claim 1, wherein said monitor is fastened by a fastener about said element and/or said coupler.

7. The safety system of claim 6, wherein said fastener includes an electrical wire that is lashed to said structure limiting access to the element and/or coupler and registering a change in state by way of the sensor should the wire be tampered with.

8. The safety system of claim 1, wherein each said monitor transmits a signal to said monitoring station to provide the receiving software with information regarding a status of the monitors.

9. The safety system of claim 1, wherein at least one said monitor includes a visual and/or audible alert should movement of said structure be sensed by said receiver.
